(19) United States
(12) Patent Application Publication
(10) Pub. No.: US 2004/0236579 A1
(43) Pub. Date: Nov. 25, 2004

(54) Cyber communicator

(76) Inventors: Jose Miguel Cardenes, Parma Heights, OH (US); Luis Enriguez Cardenes, Jersey City, NJ (US)

Correspondence Address: RENNER, KENNER, GREIVE, BOBAK, TAYLOR & WEBER, FIRST NATIONAL TOWER FOURTH FLOOR, 106 S. MAIN STREET, AKRON, OH, 44308, US

(21) Appl. No.: 10/356,809

(22) Filed: May 19, 2003

(51) Int. Cl. G10L 21/00

(52) U.S. Cl. 704/270.1

(57) ABSTRACT

A cyber communicator includes a first computing device connected to a network of computing devices which has text message capabilities and a second computing device connected to the network of computing devices. The second computing device also has text message capabilities wherein users of the first and second computing devices may correspond with each other via the network. A translation program maintained by the network of computing devices receives the text messages from one of the first and second computing devices and then translates and sends the text messages to the other of the computing devices in a translated language.

As stated the name of this invention is the Cyber Communicator, Cyber as a reference of cybernetic or machine that interact by means of electronic devices, soft wares and hard wares, Communicator as to be able help us in the communication process or to produce available caption or translation to whatever is desire to be written, such as conversation, paragraph and words.

### CROSS REFERENCE

Many other are similar to this but not quite the same, the Cyber communicator is capable to be use via the net or inter net and is capable to translate conversations written in any language chosen by the user when using the selected chat rooms, no just as a machine that translate words but as a computer system that translate conversations. As you may notice in the following pages I will explain with more details of how the Cyber Communicator works and as an example or cross-reference I have a list of other translator.

### DESCRIPTION

The cyber communicator is a computer based hardware that is capable to produce or translate captions as selected by the user on a chat room, computer net web site or conference rooms use by business people or none business people, as an example of this is if a person desires to go to a chat room where French, Spanish or English people are and that person speaks German he/she will select the language to be translated to or where he/she desires to send the message to, then when sending the message or paragraphs the translator would immediately send it in the pre-selected language so that the receptor will receive the message in hi/her speaking language and vice versa.

To be able to produce this translation both parties should have the cyber communicator unless the website provider's chat room is equipped with the appropriate hardware and programs which is again, provided by the cyber communicator 2.

This hardware is designed with material, which are not uncommon to computer hardware today, materials such as metals, plastics silicon and integrated circuits of the required proportion. The cyber communicator 2 could be installed separately with an USB port (FIG. 1), could be installed inside the computer 1 on an empty slot (FIG. 2), or if on a web site it could be installed on the main system as to allow the provider to give this service to the user (FIG. 3).

### SUMMARY

As a summary the cyber Communicator is mainly the hardware and programs capable to break with communication barrier with other people of different speaking languages, this could be use in an office as well as in our homes, allowing us to reach other people, understand them and having them understand us without having any knowledge of their language.

### DRAWINGS

In the attached drawings we can see how the cyber communicator could be use and attach to your PC and how it is used on a web site.

FIG. 1 we see a small box connected by the mean of an USB connection.

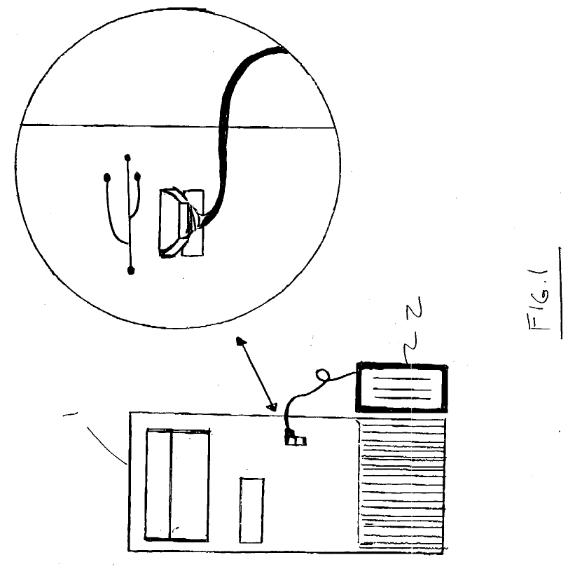

FIG. 2 The cyber communicator board or hardware could be installed in an empty slot on the PC motherboard.

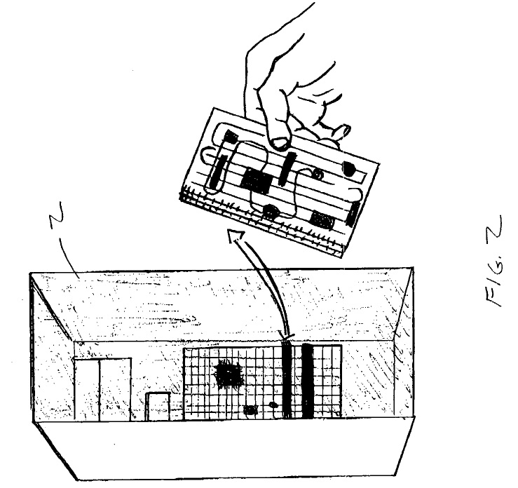

FIG. 3 Is a diagram of what the hardware might look like when developed

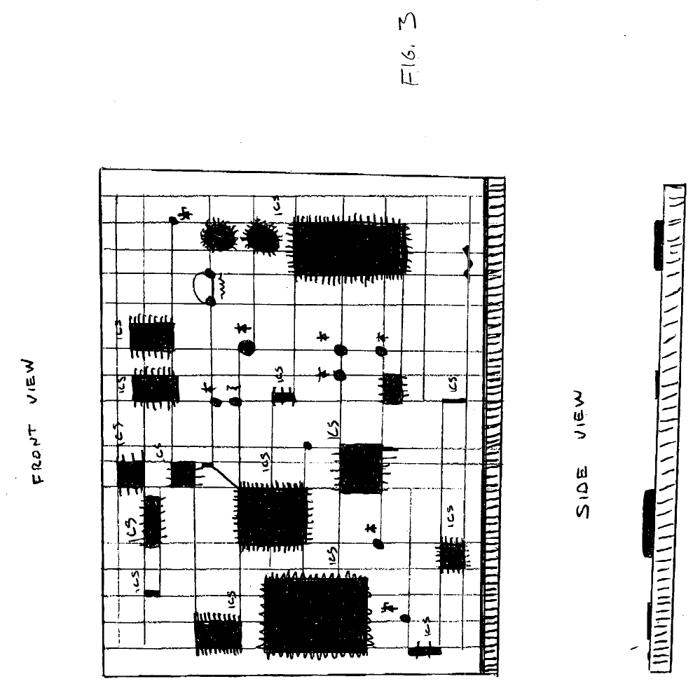

FIG. 4 The system is connected on the appropriate computer as to function on a web site.

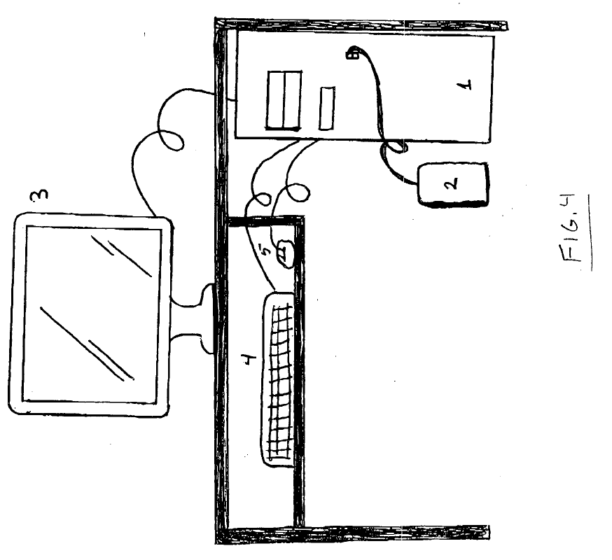

### CYBER COMMUNICATOR

The cyber communicator 2 consists of a hardware and program that translates from one language to another, as it could be use on the inter-net to chat in selected rooms. This hardware is similar to the one use on several translators, the difference is that this specific hardware will be use for chatting on the inter net, hence when the transmitter writes a paragraph, word or combination, and sends it to the receptor he/she will receive it in the language that the transmitter or receiver has selected, for example if a person is on a chat room chatting with his friends and these people only speak English and a Vietnamese person decides to join the chat room but he/she doesn't speak any English, well that's when the cyber communicator 2 comes into place, all this person has to have is the cyber communicator hardware, select the language he wants this to go to, and when the message is then sent, the receptors will receive it in the language format they would be able to understand. The receiver can also select the language he/she wants to translate what he/she is seeing on the net chat rooms, as long as the web site has the cyber communicator actively.

The way this system would work is the same basic principal the caption system works on TV or close to the way those hand held translator work. The advantage of this invention is to break the communication barrier there is on the world via the inter-net. This hardware is not difficult to fabricate, due to basic research I Jose Miguel Cardenes came to the conclusion that a hardware similar to the one the hand held translator or the caption system on TV works, so the idea for a translator to paragraph use on chat rooms is a great idea to break those communication barrier so with the fabrication of these hardware that could use independently at home with your PC or even better, a web site could have this and the user would just ask for the service.

The materials for this are just the same basic material computer hardware uses, materials such as: Silicones, transistors resistors but mainly IC or integrated circuits.

In the following pages you will see a series of detailing information together with drawings that will provide with basics information as to how the cyber communication would be developed and as how it would work.

What is claimed is:

1. A cyber communicator, comprising:
a first computing device connected to a network of computing devices, said first computing device providing text message capabilities;
a second computing device connected to said network of computing devices, said second computing device providing text message capabilities wherein users of said first and second computing devices may correspond with each other via said network; and
a translation program maintained by said network of computing devices, wherein said translation program receives text messages from one of said first and second computing devices and then translates and sends said text messages to the other of said computing devices in a translated language.

2. The cyber communicator according to claim 1, wherein said first and second computing devices allow a first user to select a first language for transmitting messages and a second user to select a second language for receiving messages.
